(19) United States
(12) Patent Application Publication
(10) Pub. No.: US 2023/0325618 A1
(43) Pub. Date: Oct. 12, 2023

(54) INTELLIGENT REAL-TIME BARCODE DETECTION AND DECODE SYSTEM BASED ON LOW-COST CAMERAS

(71) Applicant: QUALCOMM Incorporated, San Diego, CA (US)

(72) Inventors: Qian YANG, San Diego, CA (US); Chunjue Tang, San Diego, CA (US); Yuting Hu, San Diego, CA (US); Rajdeep Ganguly, San Diego, CA (US); Lei Ma, San Diego, CA (US)

(21) Appl. No.: 18/106,416

(22) Filed: Feb. 6, 2023

Related U.S. Application Data
(60) Provisional application No. 63/328,693, filed on Apr. 7, 2022.

(51) Int. Cl. G06K 7/14; G06N 3/08

(52) U.S. Cl. CPC G06K 7/1417; G06K 7/1413; G06N 3/08

(57) ABSTRACT

A processor-implemented method for detecting and decoding barcodes using an artificial neural network (ANN) includes receiving an image by the ANN. The ANN generates one or more bounding boxes corresponding to one or more barcodes located in the image. The ANN extracts a set of features of the image in a region of each of the one or more bounding boxes. The set of features of the image in the region of the one or more bounding boxes are decoded by the ANN to generate a prediction for each character of the one or more barcodes in the regions of the one or more bounding boxes.

### CROSS-REFERENCE TO RELATED APPLICATION

The present application claims the benefit of U.S. Provisional Patent Application No. 63/328,693, filed on Apr. 7, 2022, and titled “INTELLIGENT REAL-TIME BARCODE DETECTION AND DECODE SYSTEM BASED ON LOW-COST CAMERAS,” the disclosure of which is expressly incorporated by reference in its entirety.

### FIELD OF DISCLOSURE

Aspects of the present disclosure generally relate to neural networks, and more particularly, to detection and decoding of barcodes using artificial neural networks.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, pattern recognition, speech recognition, autonomous driving, and other classification tasks.

Barcodes are used in many industries to manage and track inventory or to process commercial transactions for such inventory items, for example. Typically, barcodes are detected via laser. However, such detection and decoding systems may be unable to detect and thus unable to decode barcodes that are blurred, warped, faded, or that may be partially occluded by other overlaid markings, labels, or further obscured by plastic wrapping. Conventional camera-based detection and decoding techniques are expensive and involves human labor to manual scanning. Furthermore, conventional camera-based detection and decoding techniques also have limited scanning range and may be unable to detect multiple or different types of barcodes without specialized or custom lighting solutions.

### SUMMARY

The present disclosure is set forth in the independent claims, respectively. Some aspects of the disclosure are described in the dependent claims.

In aspects of the present disclosure, a processor-implemented method includes receiving, by an artificial neural network (ANN), an image. The method also includes generating, by the ANN, one or more bounding boxes corresponding to one or more barcodes located in the image. The method further includes extracting, by the ANN, a set of features of the image in a region of each of the one or more bounding boxes. The method also includes decoding, by the ANN, the set of features of the image in the region of the one or more bounding boxes to generate a prediction for each character of the one or more barcodes in the regions of the one or more bounding boxes.

Other aspects of the present disclosure are directed to an apparatus. The apparatus has a memory and one or more processor(s) coupled to the memory. The processor(s) is configured to receive, by an artificial neural network (ANN), an image. The processor(s) is also configured to generate, by the ANN, one or more bounding boxes corresponding to one or more barcodes located in the image. The processor(s) is further configured to extract, by the ANN, a set of features of the image in a region of each of the one or more bounding boxes. The processor(s) is also configured to decode, by the ANN, the set of features of the image in the region of the one or more bounding boxes to generate a prediction for each character of the one or more barcodes in the regions of the one or more bounding boxes.

Other aspects of the present disclosure are directed to an apparatus. The apparatus includes means for receiving, by an artificial neural network (ANN), an image. The apparatus also includes means for generating, by the ANN, one or more bounding boxes corresponding to one or more barcodes located in the image. The apparatus further includes means for extracting, by the ANN, a set of features of the image in a region of each of the one or more bounding boxes. The apparatus also includes means for decoding, by the ANN, the set of features of the image in the region of the one or more bounding boxes to generate a prediction for each character of the one or more barcodes in the regions of the one or more bounding boxes.

In other aspects of the present disclosure, a non-transitory computer-readable medium having program code recorded thereon is disclosed. The program code is executed by a processor and includes program code to receive, by an artificial neural network (ANN), an image. The program code also includes program code to generate, by the ANN, one or more bounding boxes corresponding to one or more barcodes located in the image. The program code further includes program code to extract, by the ANN, a set of features of the image in a region of each of the one or more bounding boxes. The program code also includes program code to decode, by the ANN, the set of features of the image in the region of the one or more bounding boxes to generate a prediction for each character of the one or more barcodes in the regions of the one or more bounding boxes.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5A is a high-level block diagram illustrating an example architecture for detection and decoding of barcodes using an artificial neural network.

FIG. 5B is a block diagram illustrating an example architecture for barcode detection and decoding, in accordance with aspects of the present disclosure.

FIG. 6 is a flow diagram illustrating an example process for detecting and decoding barcodes, in accordance with aspects of the present disclosure.

FIG. 7 is a table of example barcode types that may be detected and decoded, in accordance with aspects of the present disclosure.

FIG. 8 is a flow diagram illustrating an example process for detecting and decoding barcodes using an artificial neural network, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

A barcode may be a machine-readable combination of black and white bars that represent a series of decimal digits. Barcodes are broadly applicable in a variety of industries including retail, and manufacturing, as well as shipping and distribution, for example. Barcodes are often used for managing and tracking inventory, for instance. Barcodes may be read using a laser or a camera and image processing. Currently, barcode detection involves finding multiple bounding box regions of barcodes from images in different environments and barcode decoding, which means obtaining the barcode number from extracted barcode regions. The barcode detection and decoding systems may be embedded in cellphones, robots, and checkout machines on low-cost cameras for real-time item scanning and recognition in daily life and in industry.

Many conventional systems include manually held laser barcode scanning solutions, which scan barcodes one by one. These systems are limited in that they involve repeated human labor of manually holding the laser or the product for scanning. The systems are inefficient in manufacturing and retail industries that are the final link in the supply chain from producers to consumers. Additionally, the scanning distance is limited, and the laser scanner is mainly designed for a one-dimensional barcode. Furthermore, barcode detection and decoding are challenging in situations of warped, damaged, partially occluded, or poor-quality barcodes.

Due to the limitations, current manually held barcode solutions prevent the implementation of automatic retailing systems or use direct human labor in supply chain and conveyor belt transportation. Furthermore, scanning barcodes one by one also hinders parallel detection and decoding, thus reducing the efficiency in the scanning process. On the other hand, conventional camera-based barcode detection and decode systems may provide lower accuracy unless expensive cameras and corresponding lightening system are employed.

To address these and other challenges, aspects of the present disclosure are directed to detection and decoding of barcodes using an artificial neural network. In accordance with aspects of the present disclosure, multiple one- or two-dimensional barcodes may be concurrently located or detected in a single image produced via a lower cost/lower resolution (e.g., less than 12 megapixels) camera. The barcodes may be concurrently decoded. Additionally, the barcodes may be detected and decoded despite poor quality (e.g., blurry image or low light) or partial occlusion due to glare from item packaging or plastic wrapping and/or damaged barcodes, for example.

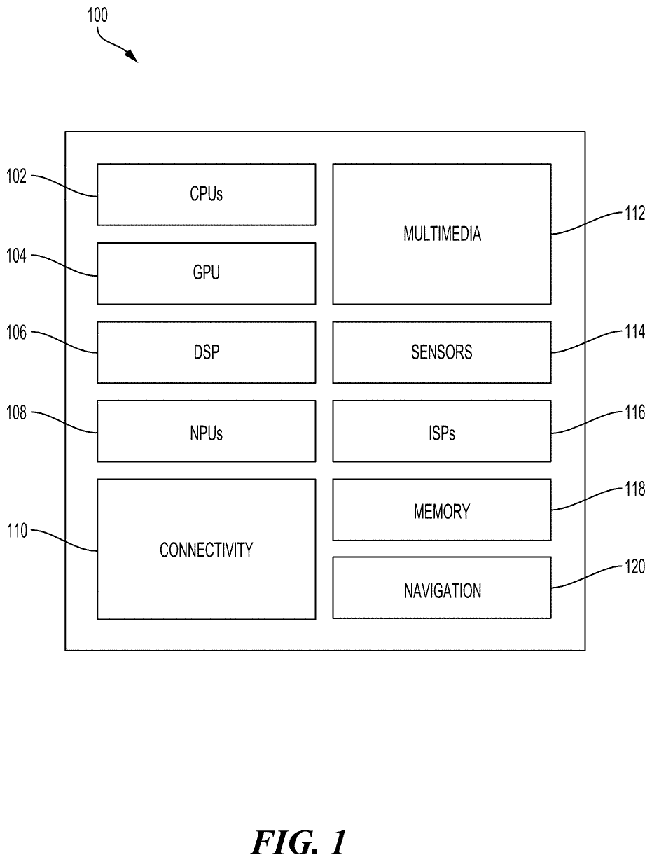

FIG. 1 illustrates an example implementation of a system-on-a-chip (SOC) 100, which may include a central processing unit (CPU) 102 or a multi-core CPU configured for detecting and decoding barcodes using an artificial neural network. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In aspects of the present disclosure, the instructions loaded into the general-purpose processor 102 may include code to receive, by an artificial neural network (ANN), an image. The general-purpose processor 102 may also include code to generate, by the ANN, one or more bounding boxes corresponding to one or more barcodes located in the image. The general-purpose processor 102 may additionally include code to extract, by the ANN, a set of features of the image in a region of each of the one or more bounding boxes. The general-purpose processor 102 may further include code to decode, by the ANN, the set of features of the image in the region of the one or more bounding boxes to generate a prediction for each character of the one or more barcodes including in the regions of the one or more bounding boxes.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

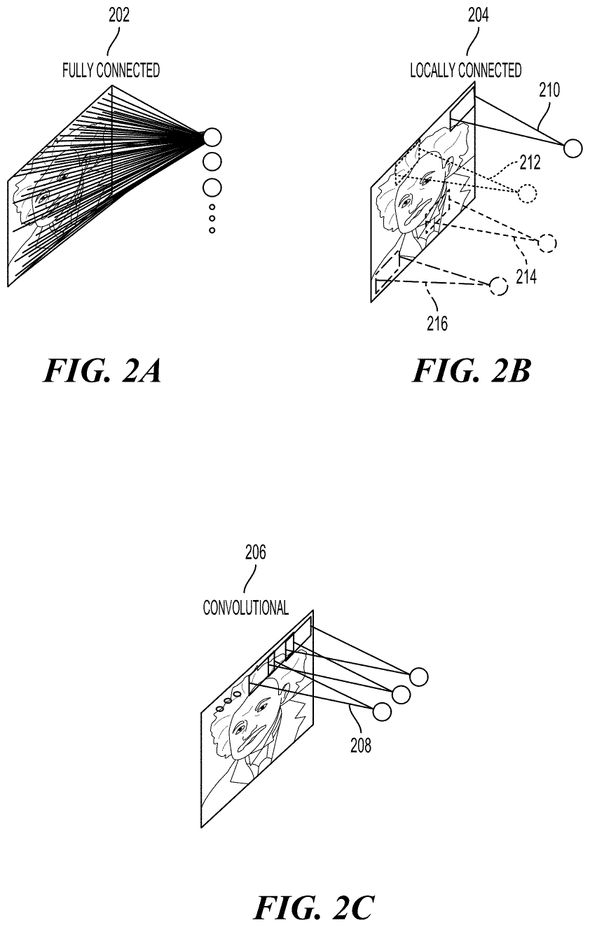

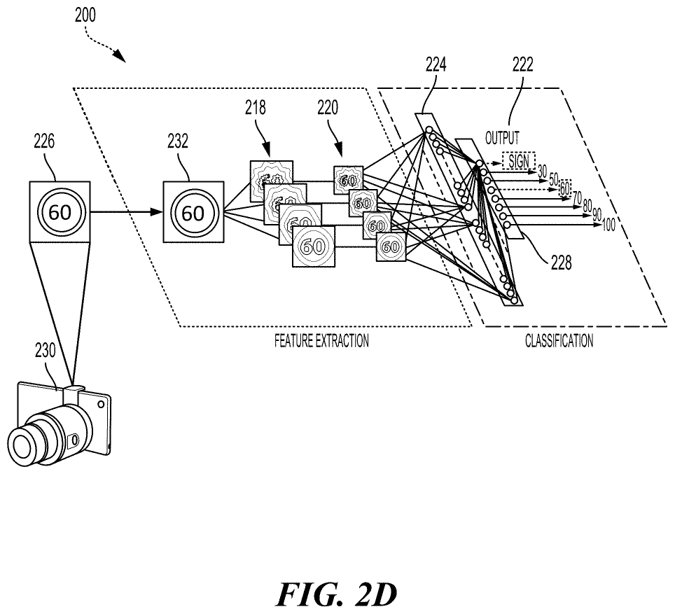

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). A RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

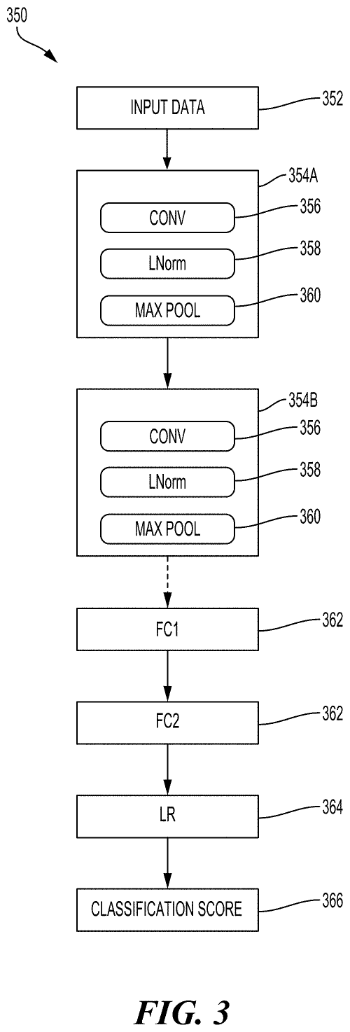

FIG. 3 is a block diagram illustrating a deep convolutional network (DCN) 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

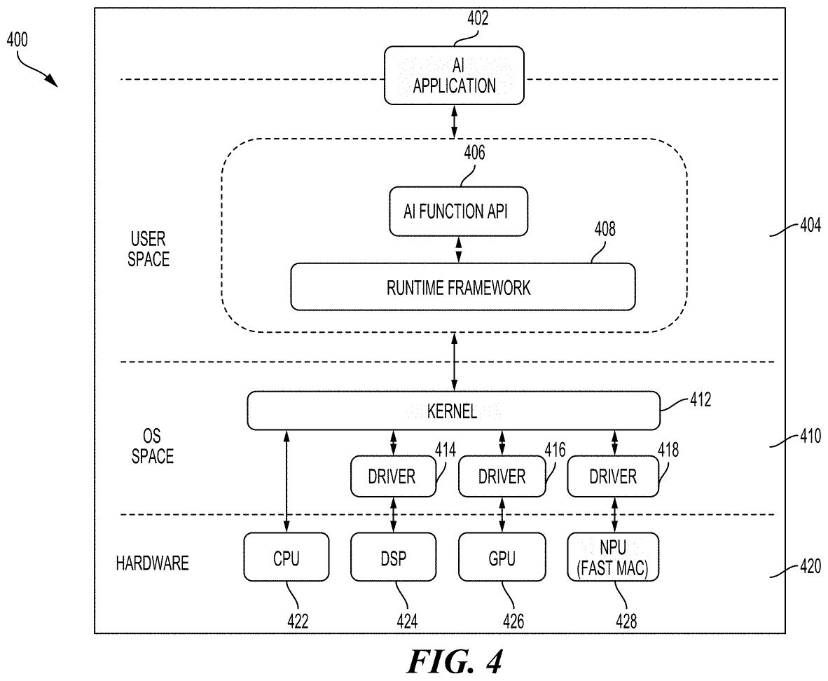

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) (which may be similar to the SOC 100 of FIG. 1) to support the detection and decoding of barcodes for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The AI application 402 may be configured to call functions defined in the user space 404 that may, for example, provide for the detection and recognition of a scene indicative of the location in which the computational device including the architecture 400 currently operates. The application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine 408, for example, to request a scene estimate at a particular time interval or triggered by an event detected by the user interface of the application. When caused to estimate the scene, the run-time engine 408 may in turn send a signal to the operating system 410, such as the Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as the driver 414-418 for the DSP 424, for the GPU 426, or for the NPU 428. In the exemplary example, the differential neural network may be configured to run on a combination of processing blocks, such as the CPU 422 and the GPU 426, or may be run on the NPU 428.

As described, aspects of the present disclosure are directed to detection and decoding of barcodes using an artificial neural network.

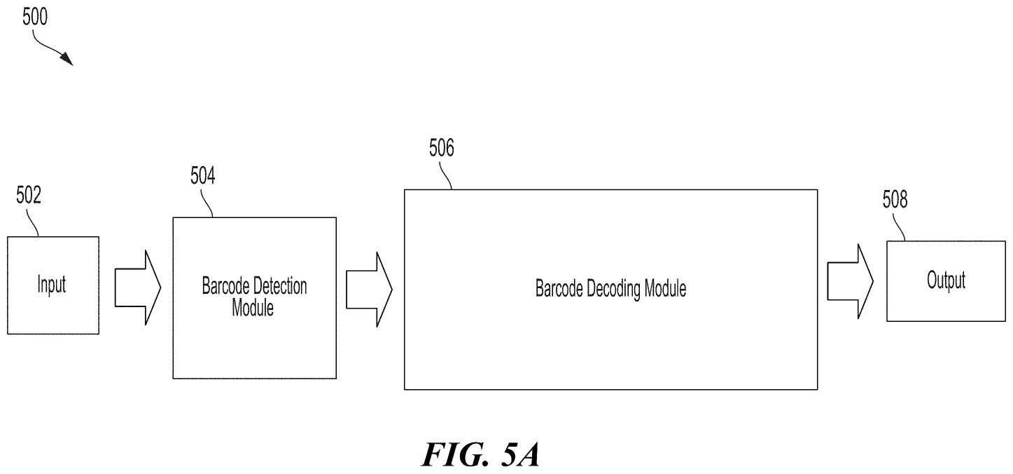

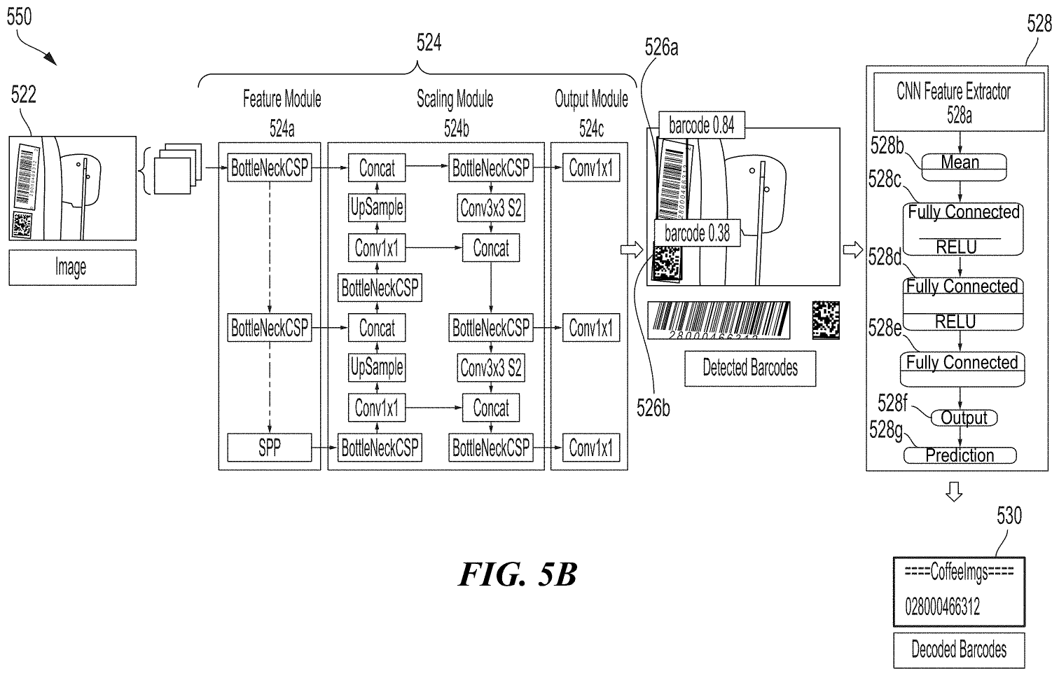

FIG. 5A is a high-level block diagram illustrating an example architecture 500 for detection and decoding of barcodes using an artificial neural network. Referring to FIG. 5A, the architecture 500 may include a barcode detection module 504 and a barcode decoding module 506. The barcode detection module 504 may receive an input 502. For purposes of clarity, the term “receive” may include access such as accessing a memory location or otherwise obtaining from a source. The input 50, for example, may comprise an image. In some aspects, the image may be supplied via a lower cost/lower resolution (e.g., less than 12 megapixel) camera such as a mobile phone camera, for instance.

The image may include one or more barcodes or the like that represents data in a visual, machine-readable form. In some aspects, the barcode may be a one-dimensional barcode (e.g., a universal product code (UPC) or a European article number (EAN)). In other aspects, the barcode may be a two-dimensional barcode (e.g., a quick response (QR) code or other matrix code). In yet other embodiments, the barcode may be a three-dimensional barcode.

The barcode detection module 504 may be configured to implement a barcode detection technique to locate barcodes within the input 502. In some examples, the barcode detection module 504 may be configured to implement a you only look once (YOLO) version 5 detection technique, for instance. The barcode detection module 504 may process the entire image of input 502 separating the image into subparts or regions. The barcode detection module 504 may process the input 502 to generate one or more bounding boxes which may correspond to one or more barcodes in the input 502. The one or more bounding boxes may include coordinates with the input 502 for the one or more candidate barcodes.

The one or more bounding boxes may be supplied to the barcode decoding module 506. The barcode decoding module 506 may extract features of the input 502 at the location of the one or more bounding boxes. The barcode decoding module 506 may decode the input 502 at the location of the one or more bounding boxes to generate an output 508 including a set of characters corresponding to the one or more barcodes included in the input 502. A character may, for example, refer to a digit, an alpha-numeric character, a special character, a mathematical symbol, or the like.

FIG. 5B is a block diagram illustrating an example architecture 550 for barcode detection and decoding, in accordance with aspects of the present disclosure. As shown in FIG. 5B, the architecture 550 may include a detection module 524 (which may be an example of the detection module 504 in FIG. 5A) and decoding module 528 (which may be an example of the decoding module 506 in FIG. 5A). The detection module 524 may be configured as a convolutional neural network, for example. The detection module 524 may receive an image 522 (which may correspond to the input 502 in FIG. 5A).

The image 522 may be supplied via a lower cost/lower resolution camera such as a mobile phone camera, for instance. The image 522 may include one or more barcodes. In the example of FIG. 5B, the image 522 includes a one-dimensional barcode and a two-dimensional barcode (e.g., a QR code). Although two barcodes are shown, this is merely an example and not limiting. Rather, additional barcodes and types of barcodes may be included within the image 522.

The detection module 524 may include a feature module 524a, a scaling module 524b, and an output module 524c. The feature module 524a may extract features of the image 522. The scaling module 524b may apply upsampling techniques according to the extracted features to scale and size objects in the image 522. The output module 524c may compute output vectors with class probabilities based on the upsampled features. The output vectors may correspond to bounding boxes with the class probabilities indicating a likelihood that each bounding box includes a barcode. Accordingly, the detection module 524 may beneficially be configured to detect barcodes that are blurry, truncated, or partially occluded.

The detection module 524 may implement a detection process to locate the barcodes in the image 522. For example, the detection module 524 may divide the image 522 into regions. The regions may include bounding boxes and probabilities that such bounding boxes include a barcode that may be calculated for each region of the image 522. The probabilities may be used to weight the bounding boxes in each region. As shown in the example of FIG. 5B, the detection module 524 outputs bounding boxes 526a and 526b with corresponding probabilities. The probability that bounding box 526a includes a barcode is 0.84 while the probability that bounding box 526b includes a barcode is 0.38. In some aspects, the detection module may indicate a detected barcode based on the probability. For example, a detection threshold (e.g., 0.50, 0.30, etc.) may be applied such that bounding boxes having probabilities below the threshold may not be detected. In some aspects, the detection module 524 may output coordinates of each of the located barcodes in the image 522. The bounding boxes 526 may be supplied to the decoding module 528.

The decoding module 528 may comprise a convolutional neural network (CNN), for example. As shown in FIG. 5B, the decoding module 528 may include a CNN feature extractor 528a. The CNN feature extractor 528a may comprise a CNN with the top (e.g., output) layer removed. The CNN feature extractor 528a may extract features of the detected bounding boxes. That is, the CNN feature extractor 528a processes the bounding boxes (e.g., 526a 526b), extracting features of the image 522 at the location of the bounding boxes (e.g., 526a 526b). The output of the CNN feature extractor 528a may be supplied to an average pooling layer (e.g., mean layer) 528b. The average pooling layer 528b may compute an average of the extracted features, which may effectively smooth out the features. The output of the average pooling layer 528b may be supplied to fully connected layers 528c, 528d, and 528e. Although three fully connected layers are shown in this example, any number of fully connected layers may be suitable. The fully connected layers 528c, 528d, and 528e successively process the features to generate an output vector. The output vector is supplied to the output layer 528f, which may apply an activation function (e.g., the softmax function) to generate a prediction 528g for each character in the detected bounding box (e.g., 526a, 526b).

In turn, the detection module may generate an output 530. The output 530 may include numbers or characters (e.g., “028000466312”) represented by the barcodes in the image 522. In various aspects, the output 530 may be extensible to different formats including different lengths and composed of alphanumeric and other characters, for example, in accordance with current and future barcode formats.

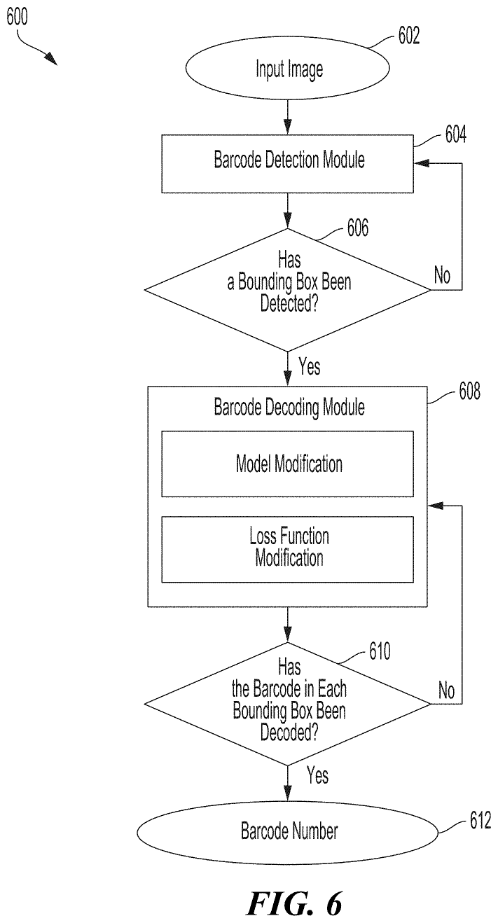

FIG. 6 is a flow diagram illustrating an example process 600 for a system that detects and decodes barcodes (or other manner of representing data in a visual, machine-readable form), in accordance with aspects of the present disclosure. The system may implement the SoC 100 (e.g., as CPU 102 or NPU 108) of FIG. 1 and/or the architectures 500, 550 of FIGS. 5A-5B.

The system may receive an input image at block 602. At block 604, the image may be supplied to a barcode detection module. The barcode detection module may localize or detect one or more barcodes within the input image. The barcode detection module may divide the image into regions. The barcode detection module may generate one or more bounding boxes in each of the regions and may generate a prediction of whether the bounding box corresponds to or includes a barcode. The bounding boxes in each region may be weighted according to the prediction to generate detected bounding boxes.

In block 606, the image may be evaluated (e.g., region by region) to determine if a bounding box (e.g., a barcode) has been detected. If a bounding box has not been detected, the process 600 may return to block 604 to continue processing the image.

If a bounding box has been detected, at block 608, the bounding box may be supplied to a barcode decoding module. In some aspects, the barcode decoding module may implement a model modification and a loss function modification. For instance, the model modification may include configuring the barcode decoding module as a CNN feature extractor (e.g., ResNet-50 without the top layer (e.g., removing the output layer)). The CNN feature extractor may be connected to an average pooling layer, fully connected layers, and an output layer. In the final output layer, each output neuron may correspond to each character in the detected barcode.

The CNN feature extractor may extract high-level features of the portion of the image included in the bounding boxes. The average pooling layer and fully connected layers may then transform extracted features to neurons or nodes that represent each character of the barcode corresponding to the bounding box. Accordingly, by incorporating the fully connected layers with the CNN feature extractor, the barcode decoding module may be enabled to generate a prediction of an output corresponding to each character of a barcode in each of the bounding boxes.

Additionally, the barcode decoding module may be trained according to a loss function L given by:

$$L ( θ ) = - {\sum }_{i = 0}^{N - 1} {\sum }_{k = 0}^{M - 1} [ 1 \{ {y}_{i k} = k \} log ( p ( x ) ) ] + ε ,$$

where N is the length of the barcode, M is the total number of possibilities for each character, yᵢₖ is the output for each character of the barcode, p(x) is the probability of a correct character, and ε is a constant (e.g., ε=8.854187817×10⁻¹²). The term k represents each possible character (e.g., numerical character (0-9), alphabetical character (a-z) or special character in position i). For instance, in an example barcode 028000466312, at position i=0, k=0; at position i=1, k=2; at position i=2, k=8.

During model training, the loss function L may be applied to minimize the difference between the output probability of each character and the ground truth barcode character in one-hot encoding, for example.

At block 610, the process 600 may determine whether the barcode in each bounding box has been decoded. If so, at block 612 the barcode number may be output. Otherwise, the process 600 may return to block 608 and continue processing additional bounding boxes detected in the input image.

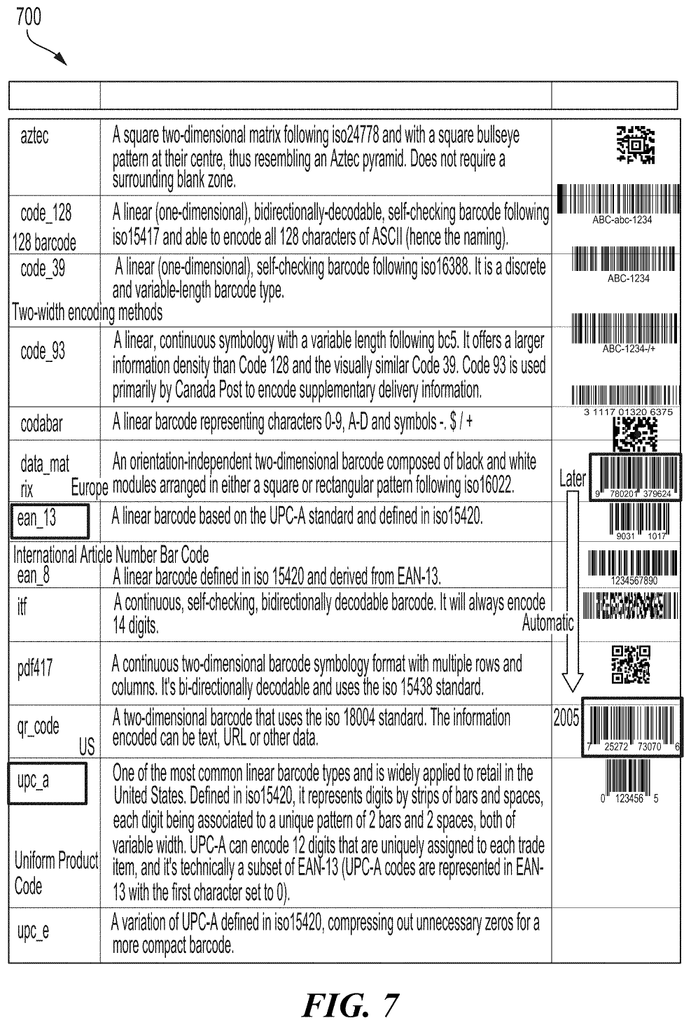

FIG. 7 is a table 700 of example barcode types that may be detected and decoded, in accordance with aspects of the present disclosure. As shown in table 700, one-dimensional barcodes (e.g., as a uniform product code (UPC) or a European article number (EAN)), as well as two-dimensional barcodes (e.g., quick response (QR) codes) may be detected and decoded. The barcodes may vary in length and pattern or shape. However, the example barcodes in table 700 is not an exhaustive list of barcodes that may be detected and decoded. Rather, aspects of the present disclosure are extensible such that different formats including different lengths and composed of alphanumeric and other characters, for example, in accordance with current and future barcode formats (of any dimension number) may be detected and decoded.

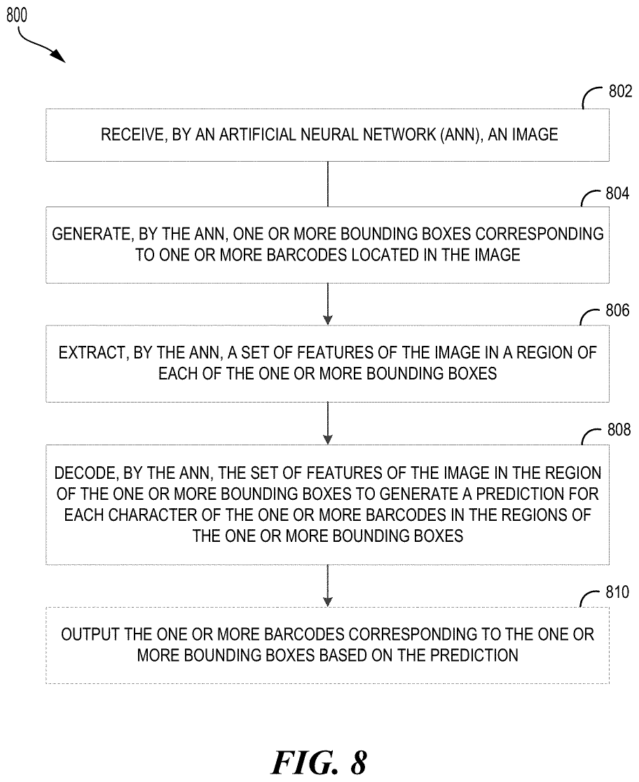

FIG. 8 is a flow diagram illustrating another example process 800 for detecting and decoding barcodes (or other manner of representing data in a visual, machine-readable form) using an artificial neural network (ANN), in accordance with aspects of the present disclosure. The process 800 may include elements similar to and/or in addition to those in process 600 of FIG. 6. The process 800 may be implemented by a processor such as CPU 102 or NPU 108 of FIG. 1, and/or may correspond to the architecture 500, 550 of FIGS. 5A-5B, for example.

At block 802, the processor receives, by the artificial neural network (ANN), an image. For instance, as described with reference to FIG. 5B, the detection module 524 may receive an image 522. The image 522 may be supplied via a lower-cost/lower resolution camera such as a mobile phone camera or webcam, for instance. The image may include one or more barcodes. In the example of FIG. 5B, the image 522 includes a one-dimensional barcode and a two-dimensional barcode (e.g., a QR code). Moreover, additional barcodes and types of barcodes may be included within the image.

At block 804, the processor generates, by the ANN, one or more bounding boxes corresponding to one or more barcodes located in the image. As described, for example with reference to FIG. 5B, the detection module 524 may implement a detection process to locate the barcodes in the image 522. For example, the detection module 524 may divide the image 522 into regions. Bounding boxes as well as probabilities that such bounding boxes include a barcode may be calculated for each region of the image 522. The probabilities may be used to weight the bounding boxes in each region. The detection module 524 may output bounding boxes (e.g., 526a, 526b) corresponding to the barcodes located in the image 522. In some aspects, the detection module 524 may output coordinates of each of the located barcodes in the image 522.

At block 806, the processor extracts, by the ANN, a set of features of the image in a region of each of the one or more bounding boxes. As described for instance with reference to FIG. 5B, the decoding module 528 may receive the bounding boxes (e.g., 526a, 526b) for the detected barcodes in the image 522. The CNN feature extractor 528a may comprise a CNN with the top (e.g., output) layer removed. The CNN feature extractor 528a may extract features of the detected bounding boxes. For instance, the CNN feature extractor 528a processes the bounding boxes (e.g., 526a 526b), extracting features of the image 522 at the location of the bounding boxes (e.g., 526a 526b).

At block 808, the processor decodes, by the ANN, the set of features of the image in the region of the one or more bounding boxes to generate a prediction for each character of the one or more barcodes in the regions of the one or more bounding boxes. As described with reference to FIG. 5B, the barcode decoding module 528 may generate a prediction 528g for each character in the detected bounding box (e.g., 526a, 526b). Each character may comprise a digit, an alpha-numeric character, a special character, a mathematical symbol, or the like.

At block 810, the processor may optionally output the one or more barcodes corresponding to the one or more bounding boxes based on the prediction. As described with reference to FIG. 5B, the decoding module 528 may generate an output 530 based on the prediction 528g. The output 530 may include characters (e.g., 028000466312) represented by the barcodes in the image 522.

In some aspects, the output may be implemented. For instance, the output may be used to conduct a commercial transaction. As another example, the output may be used to track and/or manage inventory within a supply chain.

### Example Aspects

Aspect 1: A processor-implemented method comprising: receiving, by an artificial neural network (ANN), an image; generating, by the ANN, one or more bounding boxes corresponding to one or more barcodes located in the image; extracting, by the ANN, a set of features of the image in a region of each of the one or more bounding boxes; and decoding, by the ANN, the set of features of the image in the region of the one or more bounding boxes to generate a prediction for each character of the one or more barcodes in the regions of the one or more bounding boxes.

Aspect 2: The processor-implemented method of Aspect 1, further comprising outputting the one or more barcodes corresponding to the one or more bounding boxes based on the prediction.

Aspect 3: The processor-implemented method any of the preceding Aspects, in which the image includes at least one barcode and the image of the at least one barcode is blurry, warped or partially occluded.

Aspect 4: The processor-implemented method of any of any of the preceding Aspects, further comprising: dividing the image into one or more regions; generating one or more candidate bounding boxes in each region; determining a bounding box prediction of whether each candidate bounding box in each region includes a barcode; and detecting the one or more bounding boxes based on the one or more candidate bounding boxes weighted by the bounding box prediction.

Aspect 5: The processor-implemented method of any of the preceding Aspects, in which the multiple bounding boxes are generated and a prediction for each character of multiple barcodes is generated.

Aspect 6: The processor-implemented method of any of any of the preceding Aspects, in which the image includes one or more of a one-dimensional barcode or a two-dimensional barcode.

Aspect 7: An apparatus, comprising: a memory; and at least one processor coupled to the memory, the at least one processor configured to: receive, by an artificial neural network (ANN), an image; generate, by the ANN, one or more bounding boxes corresponding to one or more barcodes located in the image; extract, by the ANN, a set of features of the image in a region of each of the one or more bounding boxes; and decode, by the ANN, the set of features of the image in the region of the one or more bounding boxes to generate a prediction for each character of the one or more barcodes in the regions of the one or more bounding boxes.

Aspect 8: The apparatus of Aspect 7, in which the at least one processor is further configured to output the one or more barcodes corresponding to the one or more bounding boxes based on the prediction.

Aspect 9: The apparatus of Aspect 7 or 8, in which the image includes at least one barcode and the image of the at least one barcode is blurry, warped or partially occluded.

Aspect 10: The apparatus of any of the Aspects 7-9, in which the at least one processor is further configured to: divide the image into one or more regions; generate one or more candidate bounding boxes in each region; determine a bounding box prediction of whether each candidate bounding box in each region includes a barcode; and detect the one or more bounding boxes based on the one or more candidate bounding boxes weighted by the bounding box prediction.

Aspect 11: The apparatus of any of the Aspects 7-10, in which the multiple bounding boxes are generated and a prediction for each character of multiple barcodes is generated.

Aspect 12: The apparatus of any of the Aspects 7-11, in which the image includes one or more of a one-dimensional barcode or a two-dimensional barcode.

Aspect 13: An apparatus, comprising: means for receiving, by an artificial neural network (ANN), an image; means for generating, by the ANN, one or more bounding boxes corresponding to one or more barcodes located in the image; means for extracting, by the ANN, a set of features of the image in a region of each of the one or more bounding boxes; and means for decoding, by the ANN, the set of features of the image in the region of the one or more bounding boxes to generate a prediction for each character of the one or more barcodes in the regions of the one or more bounding boxes.

Aspect 14: The apparatus of Aspect 13, further comprising means for outputting the one or more barcodes corresponding to the one or more bounding boxes based on the prediction.

Aspect 15: The apparatus of any of the Aspects 13-14, in which the image includes at least one barcode and the image of the at least one barcode is blurry, warped or partially occluded.

Aspect 16: The apparatus of any of the Aspects 13-15, further comprising: means for dividing the image into one or more regions; means for generating one or more candidate bounding boxes in each region; means for determining a bounding box prediction of whether each candidate bounding box in each region includes a barcode; and means for detecting the one or more bounding boxes based on the one or more candidate bounding boxes weighted by the bounding box prediction.

Aspect 17: The apparatus of any of the Aspects 13-16, in which the multiple bounding boxes are generated and a prediction for each character of multiple barcodes is generated.

Aspect 18: The apparatus of any of the Aspects 13-17, in which the image includes one or more of a one-dimensional barcode or a two-dimensional barcode.

Aspect 19: A non-transitory computer-readable medium having program code recorded thereon, the program code executed by a processor and comprising: program code to receive, by an artificial neural network (ANN), an image; program code to generate, by the ANN, one or more bounding boxes corresponding to one or more barcodes located in the image; program code to exact, by the ANN, a set of features of the image in a region of each of the one or more bounding boxes; and program code to decode, by the ANN, the set of features of the image in the region of the one or more bounding boxes to generate a prediction for each character of the one or more barcodes in the regions of the one or more bounding boxes.

Aspect 20: The non-transitory computer-readable medium of Aspect 19, in which the program code further comprises program code to output the one or more barcodes corresponding to the one or more bounding boxes based on the prediction.

Aspect 21: The non-transitory computer-readable medium of Aspect 19 or 20, in which the image includes at least one barcode and the image of the at least one barcode is blurry, warped or partially occluded.

Aspect 22: The non-transitory computer-readable medium of any of the Aspects 19-21, in which the program code further comprises: program code to divide the image into one or more regions; program code to generate one or more candidate bounding boxes in each region; program code to determine a bounding box prediction of whether each candidate bounding box in each region includes a barcode; and program code to detect the one or more bounding boxes based on the one or more candidate bounding boxes weighted by the bounding box prediction.

Aspect 23: The non-transitory computer-readable medium of any of the Aspects 19-22, in which the multiple bounding boxes are generated and a prediction for each character of multiple barcodes is generated.

Aspect 24: The non-transitory computer-readable medium of any of the Aspects 19-23, in which the image includes one or more of a one-dimensional barcode or a two-dimensional barcode.

In one aspect, the receiving means, generating means, extracting means, decoding means, and/or outputting means, a reconstruction may be the CPU 102, program memory associated with the CPU 102, the dedicated memory block 118, fully connected layers 362, NPU 428/and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described without departing from the scope of the claims.

What is claimed is:

1. A processor-implemented method comprising:
receiving, by an artificial neural network (ANN), an image;
generating, by the ANN, one or more bounding boxes corresponding to one or more barcodes located in the image;
extracting, by the ANN, a set of features of the image in a region of each of the one or more bounding boxes; and
decoding, by the ANN, the set of features of the image in the region of the one or more bounding boxes to generate a prediction for each character of the one or more barcodes in the regions of the one or more bounding boxes.

2. The processor-implemented method of claim 1, further comprising outputting the one or more barcodes corresponding to the one or more bounding boxes based on the prediction.

3. The processor-implemented method of claim 1, in which the image includes at least one barcode and the image of the at least one barcode is blurry, warped or partially occluded.

4. The processor-implemented method of claim 1, further comprising:
dividing the image into one or more regions;
generating one or more candidate bounding boxes in each region;
determining a bounding box prediction of whether each candidate bounding box in each region includes a barcode; and
detecting the one or more bounding boxes based on the one or more candidate bounding boxes weighted by the bounding box prediction.

5. The processor-implemented method of claim 1, in which the one or more bounding boxes are generated and a prediction for each character of multiple barcodes is generated.

6. The processor-implemented method of claim 1, in which the image includes one or more of a one-dimensional barcode or a two-dimensional barcode.

7. An apparatus, comprising:
a memory; and
at least one processor coupled to the memory, the at least one processor configured to:
receive, by an artificial neural network (ANN), an image;
generate, by the ANN, one or more bounding boxes corresponding to one or more barcodes located in the image;
extract, by the ANN, a set of features of the image in a region of each of the one or more bounding boxes; and
decode, by the ANN, the set of features of the image in the region of the one or more bounding boxes to generate a prediction for each character of the one or more barcodes in the regions of the one or more bounding boxes.

8. The apparatus of claim 7, in which the at least one processor is further configured to output the one or more barcodes corresponding to the one or more bounding boxes based on the prediction.

9. The apparatus of claim 7, in which the image includes at least one barcode and the image of the at least one barcode is blurry, warped or partially occluded.

10. The apparatus of claim 7, in which the at least one processor is further configured to:
divide the image into one or more regions;
generate one or more candidate bounding boxes in each region;
determine a bounding box prediction of whether each candidate bounding box in each region includes a barcode; and
detect the one or more bounding boxes based on the one or more candidate bounding boxes weighted by the bounding box prediction.

11. The apparatus of claim 7, in which the one or more bounding boxes are generated and a prediction for each character of multiple barcodes is generated.

12. The apparatus of claim 7, in which the image includes one or more of a one-dimensional barcode or a two-dimensional barcode.

13. An apparatus, comprising:
means for receiving, by an artificial neural network (ANN), an image;
means for generating, by the ANN, one or more bounding boxes corresponding to one or more barcodes located in the image;
means for extracting, by the ANN, a set of features of the image in a region of each of the one or more bounding boxes; and
means for decoding, by the ANN, the set of features of the image in the region of the one or more bounding boxes to generate a prediction for each character of the one or more barcodes in the regions of the one or more bounding boxes.

14. The apparatus of claim 13, further comprising means for outputting the one or more barcodes corresponding to the one or more bounding boxes based on the prediction.

15. The apparatus of claim 13, in which the image includes at least one barcode and the image of the at least one barcode is blurry, warped or partially occluded.

16. The apparatus of claim 13, further comprising:
means for dividing the image into one or more regions;
means for generating one or more candidate bounding boxes in each region;
means for determining a bounding box prediction of whether each candidate bounding box in each region includes a barcode; and
means for detecting the one or more bounding boxes based on the one or more candidate bounding boxes weighted by the bounding box prediction.

17. The apparatus of claim 13, in which the one or more bounding boxes are generated and a prediction for each character of multiple barcodes is generated.

18. The apparatus of claim 13, in which the image includes one or more of a one-dimensional barcode or a two-dimensional barcode.

19. A non-transitory computer-readable medium having program code recorded thereon, the program code executed by a processor and comprising:
program code to receive, by an artificial neural network (ANN), an image;
program code to generate, by the ANN, one or more bounding boxes corresponding to one or more barcodes located in the image;
program code to exact, by the ANN, a set of features of the image in a region of each of the one or more bounding boxes; and
program code to decode, by the ANN, the set of features of the image in the region of the one or more bounding boxes to generate a prediction for each character of the one or more barcodes in the regions of the one or more bounding boxes.

20. The non-transitory computer-readable medium of claim 19, in which the program code further comprises program code to output the one or more barcodes corresponding to the one or more bounding boxes based on the prediction.

21. The non-transitory computer-readable medium of claim 19, in which the image includes at least one barcode and the image of the at least one barcode is blurry, warped or partially occluded.

22. The non-transitory computer-readable medium of claim 19, in which the program code further comprises:
program code to divide the image into one or more regions;
program code to generate one or more candidate bounding boxes in each region;
program code to determine a bounding box prediction of whether each candidate bounding box in each region includes a barcode; and
program code to detect the one or more bounding boxes based on the one or more candidate bounding boxes weighted by the bounding box prediction.

23. The non-transitory computer-readable medium of claim 19, in which the one or more bounding boxes are generated and a prediction for each character of multiple barcodes is generated.

24. The non-transitory computer-readable medium of claim 19, in which the image includes one or more of a one-dimensional barcode or a two-dimensional barcode.
